(19) United States
(12) Patent Application Publication
(10) Pub. No.: US 2026/0366971 A1
(43) Pub. Date: Nov. 19, 2026

(54) EVAPORATIVE CONTROL FOR SAMPLE PREPARATION

(71) Applicant: FEI Company, Hillsboro, OR (US)

(72) Inventors: Leander Boer, Geldrop (NL); Bastiaan Hendriksen, Madrid (ES); Pleun Dona, Veldhoven (NL); Jolet de Ruiter, Eindhoven (NL)

(21) Appl. No.: 19/208,885

(22) Filed: May 15, 2025

(51) Int. Cl. G01N 1/44; B01L 3/00

(52) U.S. Cl. CPC G01N 1/44; B01L 3/502715; B01L 2200/025; B01L 2300/10; B01L 2300/1805

(57) ABSTRACT

Systems and methods are provided for a sample preparation apparatus. In at least one embodiment, the apparatus includes a sample preparation chamber, a humidity-modifying device, and a sample manipulator comprising one or more thermoelectric elements in contact with at least one or more tips of the sample manipulator. The sample manipulator grips a sample carrier. The sample preparation apparatus further includes a controller that activates the humidity-modifying device to cause a relative humidity within the sample preparation chamber to be adjusted, connects the one or more thermoelectric elements to a power supply, and adjusts an amount of power provided to the thermoelectric elements from the power supply based, at least in part, on the adjusted relative humidity.

### FIELD OF THE INVENTION

The present disclosure relates to the field of liquid-phase sample preparation for analysis. More specifically, the methods and systems described herein pertain to preparation of a sample as a thin film for subsequent instrumental analysis.

### BACKGROUND

To reduce loss of a solution-based sample during preparation of a transmission electron microscope (TEM) grid for cryogenic TEM analysis, a small volume (e.g., 1 nanoliter or less) of the sample may be deposited onto the grids. The resulting film of sample formed on the TEM grid may be prone to rapid evaporation. In some instances, the film may evaporate before sample preparation is complete, thereby impeding vitrification of the sample. System and methods to control evaporation of the sample, without altering its integrity, is therefore desirable.

### SUMMARY

As described herein, a sample preparation apparatus includes a sample preparation chamber, a humidity-modifying device in fluid communication with an inner volume of the sample preparation chamber, and a sample manipulator comprising one or more thermoelectric elements in contact with at least one or more tips of the sample manipulator, the sample manipulator gripping a sample carrier within the sample preparation chamber. The sample preparation apparatus further includes a controller comprising memory with executable instructions stored thereon that, when executed, cause the controller to activate the humidity-modifying device to cause a relative humidity within the sample preparation chamber to be adjusted and connect the one or more thermoelectric elements to a power supply. The executable instructions, when executed, further cause the controller to adjust an amount of power provided to the thermoelectric elements from the power supply based, at least in part, on the adjusted relative humidity.

In at least one embodiment, a method includes activating a humidity-modifying device to cause a relative humidity within a sample preparation chamber to be adjusted. The method also includes providing power to one or more thermoelectric elements coupled to a sample manipulator positioned within the sample preparation chamber, wherein the power is provided based on the adjusted relative humidity and a temperature of the sample preparation chamber. Furthermore, the method includes depositing a solution onto a sample carrier in contact with the sample manipulator to form a liquid film across the sample carrier.

In yet another embodiment, a sample manipulator includes a body and tips coupled to the body. The tips are formed of a heat-conductive material. The sample manipulator further includes one or more thermoelectric elements coupled to at least the tips of the sample carrier, wherein the one or more thermoelectric elements are operable to adjust a temperature of the tips of the sample manipulator to a target temperature based on a relative humidity of an environment surrounding the sample manipulator.

The foregoing and other objects, features and advantages of the invention will become more apparent from the following detailed description, which proceeds with reference to the accompanying figures.

### BRIEF DESCRIPTION OF THE SEVERAL VIEWS OF THE DRAWINGS

Embodiments will be readily understood by the following detailed description in conjunction with the accompanying drawings. The figures shown herein are for illustrative purposes and may not be to scale.

FIG. 1 illustrates a sample preparation apparatus including a sample manipulator for engaging a sample, in accordance with one embodiment.

FIG. 2 illustrates a sample manipulator having a thermoelectric system, in accordance with one embodiment.

FIG. 3 illustrates a graph comparing evaporation time for samples prepared using different schemes, in accordance with one embodiment.

FIG. 4 illustrates an effect on a sample of supplying a first amount of power to thermoelectric elements of a sample manipulator, in accordance with one embodiment.

FIG. 5 illustrates an effect on a sample of supplying a second amount of power to thermoelectric elements of a sample manipulator, in accordance with one embodiment.

FIG. 6 illustrates an effect on a sample of supplying a third amount of power to thermoelectric elements of a sample manipulator, in accordance with one embodiment.

FIG. 7 illustrates a method for operating a sample preparation apparatus having a sample manipulator with a thermoelectric system, in accordance with one embodiment.

FIG. 8 illustrates a method for adjusting a temperature of a sample manipulator having a thermoelectric system, in accordance with one embodiment.

FIG. 9 illustrates a controller used to operate a sample preparation apparatus that includes a sample manipulator with a thermoelectric system, in accordance with one embodiment.

### DETAILED DESCRIPTION

Preparation of specimens (e.g., a solution including one or more structures of interest in a liquid medium) supported on a sample carrier) for TEM imaging includes forming a thin liquid film of a specimen solution on a TEM grid. When a manual sample deposition device, such as a pipette, is used to add the specimen solution to the TEM grid, a volume of at least 1 μL or greater is deposited onto the TEM grid. Relative to a surface area of the TEM grid, the deposited volume is large, causing the liquid to form a domed layer on the TEM grid with a radius that is larger than a film thickness threshold for obtaining TEM images. If vitrified with such a large volume of liquid, a thick amorphous ice layer may be formed that reduces image contrast, causes background noise to obscure constituent features of the sample, and increases a likelihood of beam-induced degradation of the sample due to a high electron dose required to penetrate the layer of ice.

In order to decrease the thickness of the resulting layer of amorphous ice, a portion of the deposited liquid can be removed prior to vitrification. For example, excess liquid may be absorbed using paper, such as filter paper or a blotting pad, to yield a liquid film having a desired thickness across a specimen, such as approximately 50 nanometers (nm). Such removal of liquid, however, is wasteful because up to 99% of a specimen solution that is deposited on a TEM grid may be lost. Moreover, liquid films of desired thickness (e.g., 50 nm) may be prone to rapid evaporation under ambient conditions of a working environment. As an example, at a temperature of 21 °C and relative humidity of 50%, a 50 nm liquid film may evaporate faster than a minimum duration of sample preparation of 1-10 seconds. Even if the liquid film does not fully evaporate, a reduction in the liquid volume of the film may increase a concentration of solutes in the remaining film which may cause denaturation and aggregation of materials, such as proteins, in the sample.

In at least one embodiment, the issues described above may be addressed by at least moderating a temperature of a specimen (e.g., a thin film of a specimen solution dispersed onto a TEM grid) such that the temperature of the specimen is cooled to at least a dewpoint of an environment within a sample preparation chamber. By reducing the temperature of the specimen as such, evaporation of the liquid film on the TEM grid may be retarded such that an integrity of the specimen is maintained over a course of sample preparation. Evaporation of the film may further be controlled by adjusting a humidity (e.g., using a humidifier) within the sample preparation chamber. For example, by both cooling the specimen and increasing the humidity in the sample preparation chamber, evaporation of the film may be delayed such that a concentration of constituents of the sample solution remain unchanged over a period of time that extends beyond a time required to prepare a sample, where the sample includes the specimen deposited onto a sample carrier.

As such, the techniques and systems described herein achieve the technical effect of inhibiting evaporation of a sample for TEM analysis such that the sample may be prepared without loss of integrity. By leveraging a combination of sample temperature and humidity control, a sample may be maintained in an optimal state for TEM analysis without demanding undue handling and/or manipulation of the specimen or modification of a sample preparation system that would otherwise impose undesirable complexity and additional labor to a sample preparation workflow. Moreover, a sample carrier (e.g., a medium or structure supporting a specimen) may be navigated through space using a sample manipulator (e.g., tweezers or forceps) that creates a local dewpoint at a specific location within a sample chamber. In other words, a temperature of the sample manipulator may be controlled to facilitate a desired dewpoint in air immediately surrounding the sample.

In at least one embodiment, humidity control may be provided by a humidity-modifying device, such as a humidifier. Increasing a humidity (or atmospheric pressure) of an environment causes a dewpoint, e.g., a temperature at which water vapor in air condenses, in that environment to also increase. In other words, as humidity increases, dew forms (e.g., water condenses out of air) at increasingly warmer temperatures. Concomitantly, a rate of evaporation of water decreases as relative humidity increases towards a maximum relative humidity (e.g., 100% humidity) and dewpoint increases with respect to an ambient temperature.

Adjusting a humidity within a sample preparation chamber used to prepare a TEM sample may, therefore, allow evaporation of the specimen solution, the specimen solution deposited as a liquid film onto the sample carrier (e.g., grid), to be controlled. For example, by increasing the humidity in the sample preparation chamber, a dewpoint of air within the chamber may be elevated. This may decrease a rate of evaporation of a liquid film of a specimen that is deposited onto the sample carrier, which may otherwise evaporate, under ambient humidity conditions, before sample preparation is complete.

In some instances, such as when the liquid film is thin (e.g., 50 nm thickness or less), increasing the humidity in the sample preparation chamber may not delay evaporation enough to mitigate changes to a state of the TEM sample through the sample preparation process. In such scenarios, an additional system and/or method to control sample evaporation may be demanded. For example, by adjusting a temperature of the TEM sample, evaporation of the liquid film may be further suppressed.

In at least one embodiment, temperature control of a TEM sample may be achieved by manipulating, supporting, handling, and/or engaging a TEM sample using a device that includes thermoelectric elements. By coupling the device to the TEM sample, the temperature of the TEM sample may be adjusted via direct contact with the device. The temperature control provided by the device may be applied in conjunction with humidity control of a sample preparation chamber provided by a humidity-modifying device. As an example, the device with thermoelectric elements may be a sample manipulator that is formed of heat conductive materials. The sample manipulator may rely on the thermoelectric elements to generate a temperature differential across a junction of two different materials when a current passes through the sample manipulator, e.g., by creating a Peltier effect. The temperature differential formed across the sample manipulator may cause heating or cooling of the TEM specimen via conduction and convection of cold air. For example, by cooling the sample manipulator, a cold air plume is generated that sinks downwards from cooled tips of the sample manipulator and past a sample carrier supporting a specimen. Conversely, when the sample manipulator is warmed, a warm air plume may be formed that rises upwards.

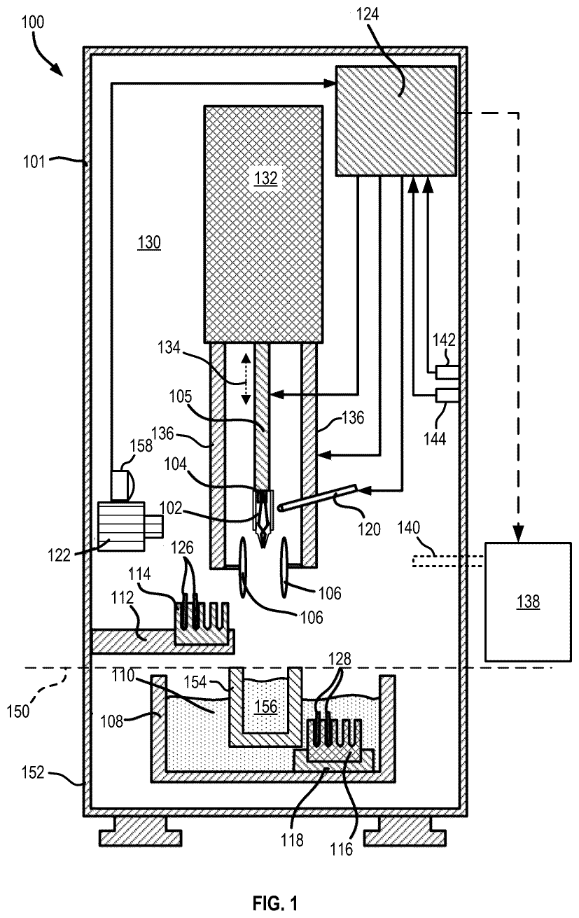

In this way, by controlling one or more of a humidity of a sample preparation chamber and a temperature of a sample to be prepared in the sample preparation chamber, evaporation of a liquid film of a specimen may be moderated without relying on techniques that demand added complexity to and excessive modification of the sample preparation chamber. Specimen loss and waste may be minimized while maintaining a desired specimen concentration, chemical composition, and native state during sample preparation. Further details of humidity and sample temperature control are provided herein and illustrated in FIGS. 1-9.

It will be noted that the terms “approximate” or “approximately,” as used herein, are intended to denote a permissible range of values that may deviate from the indicated value or values. Specifically, these terms are meant to encompass variations of ±10% from a specified value, unless otherwise indicated. This range is provided to account for potential variations due to measurement inaccuracies, manufacturing tolerances, and other factors that may influence the precise value. Therefore, the use of “approximate” or “approximately” should be interpreted in the context of this permissible range, ensuring a reasonable degree of flexibility in the interpretation of the specified values.

FIG. 1 depicts an example of a sample preparation apparatus 100 which may be used to prepare a sample for TEM analysis and imaging. The apparatus 100 includes a housing 101 which surrounds a sample preparation chamber 130 of the sample preparation apparatus 100. Components of the apparatus 100 positioned within the sample preparation chamber 130 includes a motor 132 to which a carrier support 104 is arranged at a distal end (e.g., relative to the motor 132) of a plunge arm 105. The plunge arm 105 is coupled to the motor 132 such that the plunge arm 105 can be translated along directions indicated by double-ended arrow 134 based on operation of the motor 132.

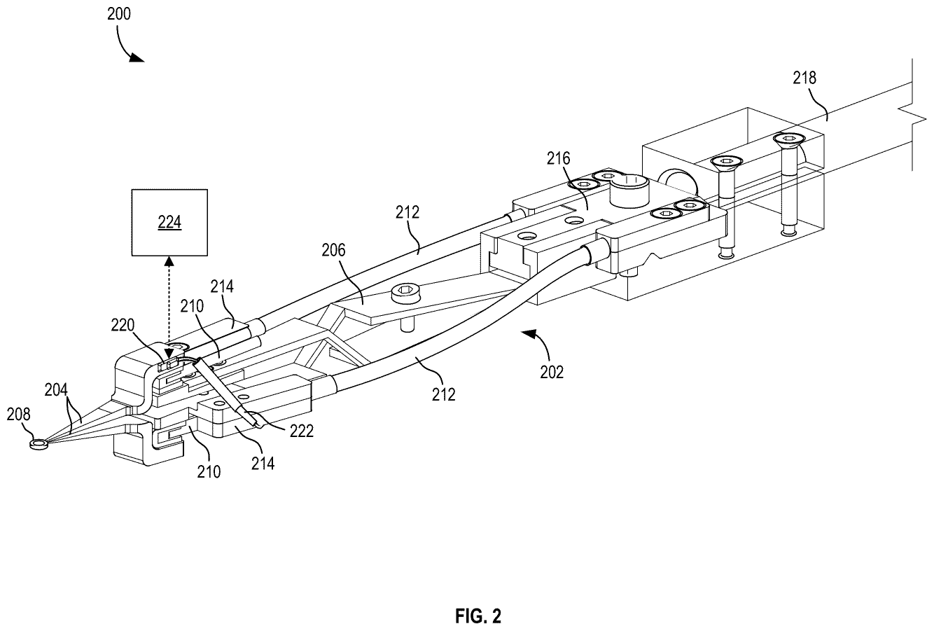

A sample manipulator 102 is coupled to the plunge arm 105 via the carrier support 104. In at least one embodiment, the sample manipulator 102 is a tweezer tool (e.g., tweezers) having prongs or tips that clamp onto at least an edge of a sample carrier (e.g., a TEM grid), thereby maintaining and supporting a position of the sample within the sample preparation chamber 130. Moreover, as described herein, the sample manipulator 102 may utilize a thermoelectrically induced Peltier effect to control a temperature of the sample manipulator 102, and thereby, as a result of direct contact and corresponding conduction, a temperature of the sample. Further details of the sample manipulator 102 are provided below and illustrated in FIG. 2.

An applicator 120 is located proximate to the sample manipulator 102 in the sample preparation chamber 130. The applicator 120 is a device that applies a specimen, such as an aqueous solution of cells, proteins and/or other materials, to sample carriers 126 that may be individually held or carried by the sample manipulator 102. As an example, the sample preparation apparatus 100 may include a first storage capsule 114 placed in a first acceptor 112 for storing the sample carriers 126 within the sample preparation chamber 130. In other examples, the first storage capsule 114 and the sample carriers 126 may be stored elsewhere, and/or the first acceptor 112 may store a liquid cryogen, such as liquid nitrogen. For example, each of the sample carriers 126 may be a TEM grid that can be clamped between tips of the sample manipulator 102 such that a plane of the TEM grid is aligned (e.g., parallel) with the directions indicated by the double-ended arrow 134. A position of the TEM grid relative to the applicator 120 may be adjusted (e.g., using the motor 132 or another device coupled to the applicator 120) to be aligned with the applicator 120. The applicator 120 includes a mechanism that allows the applicator 120 to deposit a volume of the sample onto a face of the TEM grid to form a film of the sample across at least a portion of the face of the TEM grid.

In at least one embodiment, the applicator 120 is configured to apply a small volume of the sample, such as 1 nanoliter (nL) or less, to the face of the TEM grid to form a film with a thickness of 40-60 nm. As another example, the film may be 50 nm. In yet another example, the film may be of a thickness less than 60 nm. By maintaining the thickness of the film near 50 nm in thickness, a suitable amount of amorphous ice may be formed during subsequent vitrification of the sample that preserves a native structure of molecules of the specimen without interfering with acquisition of TEM data and images based on the specimen. In another embodiment, the thickness of the film may correspond to thicknesses of layers of ice formed upon vitrification of the sample. For example, a target thickness of the film may increase with a size of a protein in a specimen that is to be imaged. A desired thickness of the film may correspond to formation of 5-10 nm of ice on either side of a protein/ice interface formed of a frozen monolayer of the protein. The applicator 120 may be any type of device capable of depositing a volume of a specimen solution that forms a sufficiently thin film of the sample without demanding removal of excess liquid. For example, the applicator 120 may be an inkjet printer, a device to perform capillary or pen writing, or a device that deposits a sample via electrospray or gas-assisted spraying.

In some instances, by using an applicator (e.g., the applicator 120) that is capable of forming a thin film of a sample, removal of excess specimen solution by way of blotting is obviated. For example, the sample preparation apparatus 100 includes a pair of arms 136 also coupled to the motor 132. The pair of arms 136 support blotter pads 106 at ends of the pair arms 136 distal to the motor 132. When a volume of a sample is applied to a TEM grid in excess of a target volume, the blotter pads 106 may be used to blot the sample and absorb at least a portion of the excess volume. For example, a distance between the blotter pads 106 may be decreased (e.g., by operating of the motor 132) such that one of the blotter pads 106 comes into contact with the sample on the TEM grid. In examples where the applicator 120 is able to deposit the target volume of the specimen solution, however, the blotter pads 106 are not used. Furthermore, in at least some embodiments, the pair of arms 136 and the blotter pads 106 may be omitted from the sample preparation apparatus 100.

The sample manipulator 102 may be used to suspend a sample within the sample preparation chamber 130 above a cryogenic container 108 in which a first cryogenic liquid 110 is stored. As indicated by dashed line 150, the cryogenic container 108 may be placed in a compartment 152 that is separate from the sample preparation chamber 130 and arranged below the sample preparation chamber 130. The first cryogenic liquid 110 may be liquid nitrogen, for example, although other types of cryogenic liquids are possible. Within the cryogenic container is a secondary reservoir 154 that stores a second cryogenic liquid 156. In at least one embodiment, the second cryogenic liquid 156 is liquid ethane, which is used to vitrify a sample. For example, the second cryogenic liquid 156 may provide faster and more even cooling than the first cryogenic liquid 156. As such the first cryogenic liquid 156 may be used to maintain a temperature of the secondary reservoir 154 sufficiently low to maintain the second cryogenic liquid 156 in a liquid phase.

The cryogenic container 108 is arranged in a separate compartment because a lower temperature of the first and second cryogenic liquids 110, 156, relative to an atmosphere within the sample preparation chamber 130, causes moisture to condense in and/or on the second cryogenic liquid 156 which causes specimen contamination. As such, after a specimen is prepared in the sample preparation chamber 130, a door of the sample preparation chamber 130 is opened to allow the sample to be rapidly descended into the secondary reservoir 154. By using the plunge arm 105 to lower a specimen into the second cryogenic liquid 156, a specimen coating a TEM grid of the sample can be rapidly frozen to form a vitrified sample. In one example, the vitrified sample is placed in a second storage capsule 116 on a second acceptor 118, where vitrified samples 128 can be stored in the first cryogenic liquid 110 (or some other cryogenic fluid), to maintain the vitrified samples 128 in a frozen state.

The sample preparation apparatus 100 further includes a humidity-modifying device 138, such as a humidifier, which is in fluid communication to an inner volume, e.g., interior, of the sample preparation chamber 130. The humidity-modifying device 138 may be used to adjust a humidity within the sample preparation chamber 130 by injecting water vapor into an atmosphere or environment within the sample preparation chamber 130. For example, the humidity-modifying device 138 may include a nozzle 140 that is coupled to an interior of the sample preparation chamber 130 through a port in a wall of the sample preparation chamber. A rate of water vapor injection into the sample preparation chamber 130 by the humidity-modifying device 138 may be varied according to a desired humidity level to be obtained. As an example, a relative humidity in the sample preparation chamber 130 may be elevated by increasing injection of water vapor by the humidity-modifying device 138. The relative humidity may be decreased by, for example, reducing or terminating water vapor injection by the humidity-modifying device 138 and purging the sample preparation chamber 130 with ambient air. In at least one embodiment, the humidity-modifying device 138 may be paired with a circulation/mixing device, such as a fan (not shown in FIG. 1), to compel mixing and homogenizing of the injected water with air inside the sample preparation chamber 130. In another embodiment, the humidity-modifying device 138 may include the circulation/mixing device, e.g., the circulation/mixing device may be integrated with the humidity-modifying device 138. By promoting mixing and homogenizing of water vapor and air within the sample preparation chamber 130, variations in relative humidity of sample preparation chamber 130 with respect to space and/or time may be reduced and/or mitigated.

Engagement of a sample carrier by the sample manipulator 102 can be monitored by, for example, a camera 122. For example, a position of the camera 122 may be adjusted, e.g., by a motor, to align a field-of-view of the camera 122 with the tips of the sample manipulator 102 to acquire an image thereof. As an example, a light source 158 may be included in the sample preparation apparatus 100 to illuminate a targeted imaging area of the specimen. The image obtained by the camera 122 is provided to a controller 124, which uses the image to adjust the position of the camera 122, the sample manipulator 102, and/or the applicator 120. The controller 124 is also used to control positions of the plunge arm 105 and the pair of arms 136 by facilitating actuation and operation of the motor 132. In addition, the controller 124 is communicatively coupled to the applicator 120 to control operation of the applicator 120. The controller 124 may optionally be communicatively coupled to the humidity-modifying device 138 to effect activation and deactivation thereof based on a humidity level detected in the sample preparation chamber 130.

In some instances, the controller 124 sends instructions to actuators of the sample preparation apparatus 100 (e.g., the motor 132, the applicator 120, the humidity-modifying device 138) in response to signals received from various sensors and detectors of the apparatus 100. For example, the apparatus 100 may include one or more temperature sensors 142, which may be positioned at various locations of the apparatus 100, such as proximate to or at the sample manipulator 102. The controller 124 can thereby receive information regarding a temperature of a specimen, or a temperature within the sample preparation chamber 130. In addition, the apparatus 100 may include one or more humidity sensors 144, which may be positioned in various locations within the sample preparation chamber 130 to detect a humidity level (e.g. a relative humidity) of the environment in the sample preparation chamber 130 and transmit a signal to the controller 124. Other sensors in addition to the temperature sensors 142 and the humidity sensors 144, e.g., position sensors, speed sensors, etc., may be included in the sample preparation apparatus but are not shown in FIG. 1 for brevity.

The controller 124 includes one or more processors and memory storing executable instructions to cause the one or more processors to perform various tasks and functions based on various non-transitory signals. For example, the controller 124 receives signals from sensors of the sample preparation apparatus 100 (e.g., the temperature sensors 142 and the humidity sensors 144) and processes the signals according to predetermined algorithms. The processed signals are output to various actuators of the apparatus 100 to cause the actuators to be activated and operated. The controller 124 is capable of real-time processing and is further configured to receive input from, for example, a user and carry out operations based on the input. Furthermore, the controller 124 includes communication interfaces for external connectivity, allowing for remote monitoring, diagnostics, and updates.

An example of a sample manipulator 200 for a sample preparation apparatus is shown in FIG. 2. In at least one example, the sample manipulator 200 is an embodiment of the sample manipulator 102 of the sample preparation apparatus 100 of FIG. 1. The sample manipulator 200 utilizes a thermoelectric system 202 to induce cooling (and/or warming) of a set of tips 204 of the sample manipulator 200. The set of tips 204 are coupled to ends of tweezers 206, which may be in a reverse configuration (e.g., reverse action tweezers) such that when no external forces are imposed on the tweezers 206, the tweezers 206 are in a closed position and the set of tips 204 are pressed against one another. In the closed position, the set of tips 204 contact one another, unless an object is positioned therebetween, such as a sample 208. When opposing forces squeeze a body (e.g., a central region relative to the tweezers' length) of the tweezers 206 together, the set of tips 204 are spaced away from one another to allow an object to be inserted therebetween. Upon releasing pressure imposed on the body of the tweezers 206 by the opposing forces, the set of tips 204 clamp the object placed therebetween and maintain the object in place relative to the tweezers 206. The tweezers 206 may be formed of a rigid, durable material, such as aluminum or stainless steel, for example.

The tips 204 may be fixedly coupled to the ends of the tweezers 206 using an adhesive, such as glue or a resin. In another example, the tips 204 may be attached to the ends of the tweezers 206 using mechanical fasteners, such as bolts. By using mechanical fasteners, detachment of the tips 204 when subjected to large variations in temperature, such as during vitrification of the sample 208, may be circumvented.

As shown in FIG. 2, the sample 208 may include a support carrier, such as a grid. In at least one embodiment, a support carrier of the sample 208 includes one or more grids. For example, the support carrier may be a single grid with a central region formed of a mesh or may be a stack or two or more grids, each including a central mesh area, that are formed of the same or different materials. An outer, rigid frame of the support carrier may be formed of a metal, such as gold, copper, nickel, and/or molybdenum. The mesh of the support carrier may also be formed of a metal and may optionally be overlaid with a porous carbon film, or a film formed of some other material. The sample 208 may be handled by gripping the sample 208 along its outer rigid frame with the tips 204 of the sample manipulator 200, as illustrated in FIG. 2.

The tips 204 may terminate at narrow pointed ends to minimize a surface area of the tips 204 that contact the sample 208 when the sample 208 is clamped between the tips 204. In at least one embodiment, the tips 204 are formed of a heat conductive material such as a metal. For example, the tips 204 may be formed of copper or aluminum. By forming the tips 204 from a heat conductive metal, heat may be extracted from the tips 204 due to contact between the tips 204 and thermoelectric elements 210, which are components included in the thermoelectric system 202.

As shown in FIG. 2, at least a portion of each of the thermoelectric elements 210 are in face-sharing contact with surfaces of the tips 204. In at least one embodiment, the thermoelectric elements 210 may be thermoelectric coolers or Peltier devices that cause a temperature of the tips 204 to be reduced (or warmed). The thermoelectric elements 210 may be solid-state devices that create a heat flux at a junction of two different types of materials, e.g., the Peltier effect. For example, the thermoelectric elements 210 may be formed of two or more different types of semiconducting materials and metallic junctions are positioned between the different types of semiconducting materials. The thermoelectric elements 210 may further include metallic terminals (not shown in FIG. 2) that allow a current to be applied to the thermoelectric elements 210, e.g., by connecting the terminals to a power supply. By applying a current to the thermoelectric elements 210, a portion of the thermoelectric elements 210 on one side of a junction becomes cooler while a portion of the thermoelectric element 210 on the other side of the junction becomes warmer. As an example, a portion of the thermoelectric elements 210 on one side of a junction, and in direct contact with the tips 204, may decrease in temperature while a portion of the thermoelectric elements 210 on an opposite side of the junction, and not in contact with the tips 204, may increase in temperature when a current is applied to the thermoelectric elements 210 in a first direction. When the current is applied to the thermoelectric elements 210 in a second direction, opposite of the first direction, the portion of the thermoelectric elements 210 in contact with the tips 204 may increase in temperature while the portion of the thermoelectric elements 210 on the other side of the junction may decrease in temperature.

In one example, the thermoelectric elements 210 are coupled to the tweezers 206 using an adhesive, such as glue or resin. Furthermore, gaps between thermoelectric elements 210 may be filled with epoxy resin.

The thermoelectric elements 210 may be mechanically and conductively coupled to heat pipes 212 by first interfaces 214, the heat pipes 212 and first interfaces 214 also included in the thermoelectric system 202 of the sample manipulator 200. The first interfaces 214 may be formed of a heat conductive material, e.g., a metal such as copper or aluminum, and may connect the thermoelectric elements 210 to the heat pipes 212. The heat pipes 212 may be tubes formed of a heat conductive material that efficiently transfer heat away from the thermoelectric elements 210. For example, the heat pipes 212 may be formed of copper, aluminum, stainless steel, or nickel. In one example, the heat pipes 212 may optionally be filled with a working fluid such as water, ammonia, or an organic fluid, among others. The working fluid may flow between the heat pipes 212 and, for example, an evaporator, to allow evaporation and condensation of the working fluid to assist in drawing heat away from the thermoelectric elements 210.

The heat pipes 212 may be coupled, at distal ends with respect to the thermoelectric elements 210, to a second interface 216. The second interface 216 may be formed of a heat conductive material, such as copper or aluminum, and may mechanically and conductively couple the heat pipes 212 to a plunge arm 218, which is similar to the plunge arm 105 of FIG. 1. By coupling the heat pipes 212 to the plunge arm 218 via the second interface 216, heat extracted from the thermoelectric elements 210 through the heat pipes 212 can be conductively transferred to the plunge arm 218 and dissipated to ambient surroundings (e.g., air).

The sample manipulator 200 may also include at least one temperature sensor 220. In some examples, more than one temperature sensor 220 may be coupled to the sample manipulator 200 at various locations along the sample manipulator 200, such as at the tips 204 (as shown in FIG. 2), along the body of the tweezers 206, along the thermoelectric elements 210, and/or along the plunge arm 218. As described above with reference to the temperature sensors 142 and the controller 124 of FIG. 1, the temperature sensor 220 may be communicatively coupled to a controller 224. For example, the temperature sensor 220 may measure a temperature detected at the tips 204 of the sample manipulator 200 and transmit the measurement to the controller 224. The sample manipulator 200 may include additional sensors, such as a humidity sensor, for monitoring environmental conditions surrounding the sample manipulator 200.

The temperature sensor 220 is coupled to a power supply via a cable 222. Furthermore, the thermoelectric elements 210 may also be coupled to a power supply via one or more cables that are not shown in FIG. 2 for clarity. The temperature sensor 220, the thermoelectric elements 210, and any other sensors of the sample manipulator 200 may be communicatively linked to the controller 224 by a wireless and/or hard-wired connection. In at least one embodiment, the controller 224 may use a signal received from the temperature sensor 220 to monitor the temperature of the tips 204 of the sample manipulator 200 and adjust a supply of power to the thermoelectric elements 210 to achieve a desired cooling (or warming) of the tips 204. As such, the signal may be used as feedback for adjusting operation of the thermoelectric elements 210. Other sensors coupled to the sample manipulator 200 may be used in a similar manner.

It will be appreciated that a configuration of the sample manipulator 200 illustrated in FIG. 2 is a non-limiting example of a sample manipulator having a mechanism for temperature control. For example, other arrangements to achieve temperature modification of a sample manipulator may include embedding liquid cooling system into the sample manipulator to circulate a coolant, or coupling Peltier devices (e.g., the thermoelectric elements 210 of FIG. 2) to various locations along a sample manipulator, such as to a plunge arm coupled to the sample manipulator, or to a body of the sample manipulator rather than tips thereof. In one example, a plunge arm coupled to the sample manipulator may be convectively cooled which may allow higher power to be supplied to Peltier devices of the sample manipulator to promote cooling of a sample. Additionally or alternatively, the sample manipulator may be clamped onto another cold object, when not engaging a sample, thereby reducing a temperature of the sample manipulator and causing heat to be extracted from a sample to the sample manipulator upon engagement. In yet another additional or alternative embodiment, air that is conditioned to be near a dewpoint of an environment surrounding a sample may be injected within proximity to the sample using, for example, a nozzle.

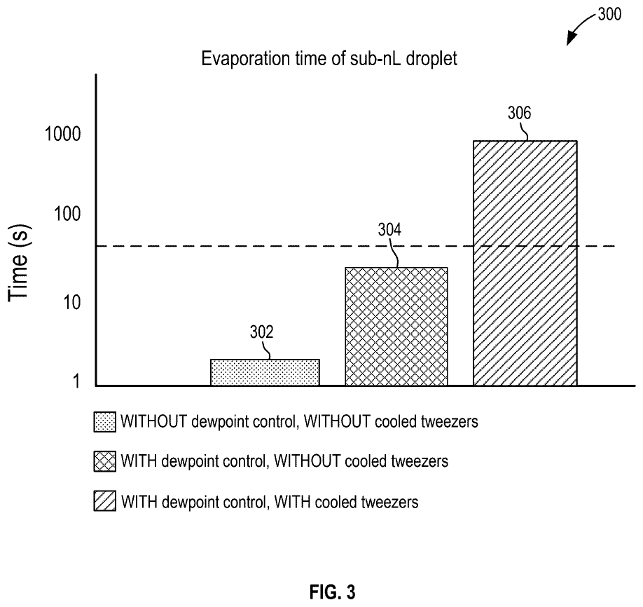

As described above, an evaporation time of a liquid film of a TEM sample may be prolonged by increasing a humidity of an atmosphere surrounding the TEM sample, hereafter referred to as dewpoint control. The evaporation time may be further prolonged by handling the TEM sample using a sample manipulator having a thermoelectric system that can cause a temperature of the TEM sample to be decreased. A comparison of evaporation times for different scenarios is shown in FIG. 3.

FIG. 3 depicts a graph 300 of a duration of time, in seconds, for a droplet of water to fully evaporate according to different sample preparation schemes. For each scheme shown in FIG. 3, a droplet is deposited onto a TEM grid using an inkjet printer, the droplet having a volume of 230 picoliters (pL). Evaporation of the droplet is monitored using a camera. The graph 300 includes a first column 302, a second column 304, and a third column 306. The first column 302 corresponds to an evaporation time of a droplet when the droplet is subjected to an environment without dewpoint control and without cooling of a sample manipulator used to handle the TEM grid. For example, the droplet is maintained in a sample chamber at an ambient temperature of 23 °C and a relative humidity of 38%. The droplet evaporates within approximately 2 seconds.

The second column 304 corresponds to an evaporation time of a droplet when the droplet is subjected to an environment with dewpoint control and without cooling of the sample manipulator used to handle the TEM grid. For example, the droplet is maintained in the sample chamber at an ambient temperature of 23 °C and a relative humidity of 88%, where the relative humidity corresponds to a dewpoint of 21 °C. The droplet evaporates within approximately 24 seconds.

The third column 306 corresponds to an evaporation time of a droplet when the droplet is subjected to an environment with dewpoint control and cooling of the sample manipulator used to handle the TEM grid. For example, the droplet is maintained in the sample chamber at an ambient temperature of 23 °C and a relative humidity of 88%. A sample manipulator, such as the sample manipulator 200 of FIG. 2, is used to handle the TEM grid. Thermoelectric elements (e.g., Peltier devices) of the sample manipulator are connected to a power supply set to deliver 10 mW of electrical power to the thermoelectric elements, which are connected in parallel. A current generated at the thermoelectric elements results in a temperature of tips of the sample manipulator to be decreased to 21 °C, which causes the TEM grid to also be cooled to 21 °C, where 21 °C is approximately equal to a dewpoint corresponding to the temperature and relative humidity within the sample chamber. A size of the droplet remains unchanged over a period of at least 800 seconds.

Results of the comparison, as illustrated in FIG. 3, indicate that moderation of humidity such that an environment surrounding a sample is near a dewpoint of the environment (e.g., within 2 °C of the dewpoint) results in an increase in evaporation time of approximately 12 times relative to a reference scenario represented by the first column 302 of FIG. 3. By both moderating the humidity to provide dewpoint control and cooling a sample manipulator in contact with a sample, an evaporation time of a sub-nL droplet is increased by approximately 400 times relative to the reference scenario, and by approximately 33 times relative to dewpoint control alone. A combination of dewpoint control and sample temperature control may therefore have a pronounced effect on suppressing evaporation of a thin liquid film of the sample, until sample preparation can be completed (e.g., vitrification of the sample is performed).

For the sample preparation schemes corresponding to the results depicted in FIG. 3, the sample preparations were performed using grids that were not glow discharged. The sample grids of the sample preparation schemes of FIG. 3 were therefore associated with relatively poor wettability and large contact angles. For TEM applications, however, TEM grids may undergo glow discharge prior to specimen deposition, which results in lower contact angles and improved wetting. Moreover, treatment of grids by glow discharge causes deposited droplets (e.g., of a specimen) to form thinner films with greater surface to volume ratios. As such, for practical use-case scenarios where glow discharge is used, advantages of suppression of specimen evaporation may be more pronounced compared to the demonstrative experiment depicted in FIG. 3.

Furthermore, cooling of a sample, as provided by thermoelectric cooling of a sample carrier used to handle the sample, may be used to balance dewpoint control provided by a humidity-modifying device (e.g., a humidifier) to maximize delay of evaporation without causing undesirable condensation of moisture within a sample preparation chamber. For example, while adjusting a humidity level within the sample preparation chamber to a dewpoint of air within the chamber may suppress evaporation, increasing the humidity level such that the temperature within the chamber is equal to (or below) the dewpoint may cause water to condense out of the air onto surfaces of the sample chamber. Maintaining the humidity level below the dewpoint, however, may not suppress evaporation enough to circumvent a change in concentration of a specimen solution that forms the liquid film.

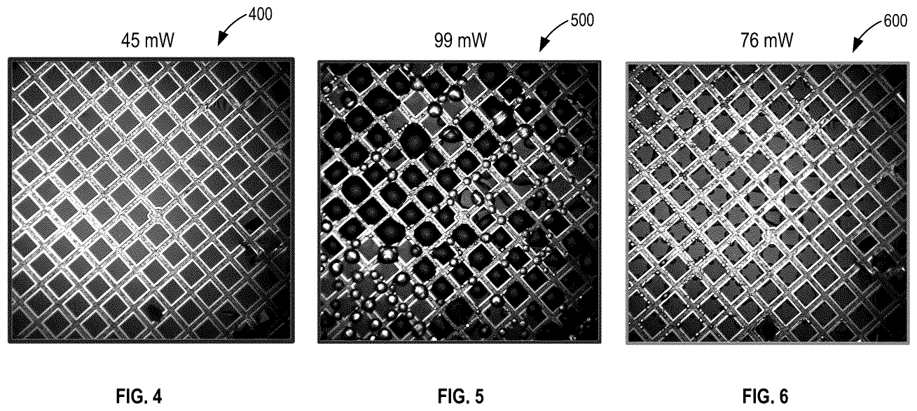

As such, suppression of evaporation may be optimized based on selective cooling of the sample manipulator. Similar to an effect of humidity control, insufficient cooling of the sample (via the sample manipulator) for a given dewpoint within the sample chamber may not delay evaporation enough to maintain an integrity of the specimen while excessive cooling of the sample for the given dewpoint may cause moisture to condense onto the sample. Images exemplifying such effects are illustrated in FIGS. 4-6.

In at least one embodiment, cooling of a sample manipulator (e.g., the sample manipulator 200 of FIG. 2) is moderated based on an amount of power supplied to Peltier devices (e.g., the thermoelectric elements 210 of FIG. 2) of the sample manipulator. Precise cooling of the sample manipulator, and of a sample in contact with the sample manipulator, may thereby be achieved by selecting a power level based on a dewpoint and humidity level of an environment surrounding the sample manipulator.

For example, turning to FIG. 4, a first image 400 is shown of a portion of a first grid. The first grid is held in place within a chamber by a sample manipulator having a thermoelectric system as shown in FIG. 2. An environment within the chamber is maintained at a given relative humidity and a temperature in the chamber is above a dewpoint corresponding to the given relative humidity. A power level of 45 mW is supplied to the sample manipulator which causes the sample manipulator, and the first grid, to be cooled to a temperature that remains above the given dewpoint. The TEM grid remains dry. In such conditions, a liquid film of ~50 nm or less in thickness may rapidly evaporate.

In contrast, as shown in FIG. 5, a second image 500 depicts an effect of excessive cooling of a sample manipulator. For a second grid shown in the second image 500, the second grid is held by the same sample manipulator within a chamber maintained at the same given relative humidity and given temperature as for the first grid. A power level of 99 mW is supplied to the sample manipulator, cooling the sample manipulator and the second grid to below the given dewpoint. As a result, droplets of water condense onto the second grid. In such conditions, a liquid film of ~50 nm thickness may be diluted by condensation of moisture onto the second grid. Furthermore, condensation of moisture onto surfaces within the sample chamber may promote growth of organisms, such as bacteria and fungi, and lead to issues with sanitation and cross-contamination, as well as increasing a likelihood of short circuiting of electrical components.

When the power supplied to the sample manipulator is optimized based on the given dewpoint, however, evaporation may be suppressed without causing undesirable condensation of ambient moisture. For example, a third image 600 is shown in FIG. 6 where a third grid is engaged by the same sample manipulator and the sample manipulator, along with the third grid, are placed in the chamber under the same given temperature and given relative humidity as described previously for FIGS. 4 and 5. A power supply of 76 mW is provided to the sample carrier which cools the sample manipulator and the third grid to the dewpoint. As depicted in FIG. 6, a small amount of condensation (e.g., less than the condensation shown in FIG. 5) forms on the third grid.

The results illustrated in FIGS. 4-6 indicate that by selectively cooling a sample manipulator (e.g., by adjusting power supplied to Peltier devices of the sample manipulator), both evaporation of a liquid film and condensation of moisture onto a specimen may be controlled. In at least one embodiment, optimal suppression of evaporation may be achieved by conditioning an environment within a sample preparation chamber to be at a temperature near but above a dewpoint of the environment by a threshold margin. For example, a humidity within the sample preparation chamber may be set to obtain a relative humidity of ~90% based on ambient temperature of the sample preparation chamber. The ambient temperature is above the dewpoint (e.g., ~10 % above the dewpoint or less) by a small increment which mitigates condensation of moisture in the sample preparation chamber. The sample manipulator is cooled to the dewpoint, thereby also cooling the sample to a temperature corresponding to the dewpoint via conduction. By maintaining the sample temperature at the dewpoint, while air surrounding the specimen is maintained above the dewpoint by the threshold margin, a liquid film of the specimen does not evaporate for a prolonged period of time (e.g., at least as long as a duration of sample preparation). Concomitantly, moisture from ambient air does not condense onto the sample.

In some instances, evaporation of a specimen liquid film may be suppressed solely by thermoelectrically cooling tips of a sample manipulator, without adjusting a relative humidity of an environment surrounding the specimen liquid film using a humidity-modifying device. In other words, within a sample preparation chamber, the sample manipulator may be cooled such that a sample clamped by the sample manipulator is cooled to below a dewpoint of air within the chamber, where the dewpoint corresponds to an ambient relative humidity and ambient temperature in the sample preparation chamber. An amount of cooling required to cool the specimen to the dewpoint, however, may be large and may demand undesirable energy consumption. Using a combination of dewpoint control (e.g., by increasing relative humidity) and cooling the sample manipulator may provide a more energy, time, and cost-efficient option.

Furthermore, when an ambient environment surrounding a sample and a sample manipulator is close to a dewpoint thereof, a heat flux through tips of the sample manipulator may be reduced. As a result, narrower and/or smaller tips can be used, thereby decreasing a thermal mass of the tips. By decreasing the thermal mass of the tips, the sample may be cooled more rapidly when the sample, and the tips, are submerged in a cryogenic liquid (e.g., plunge freezing) to vitrify the sample.

In at least one embodiment, temperature control provided by a sample manipulator configured with a thermoelectric system may be further leveraged to increase an operational or useful lifespan of at least a portion of the sample manipulator. For example, the sample manipulator may be used, in conjunction with a plunge arm and a motor (e.g., the plunge arm 105 or 218 of FIGS. 1 and 2 and the motor 132 of FIG. 1) to plunge a sample into a cryogenic liquid after a liquid film of a specimen solution is applied to a TEM grid of the sample. This vitrifies the sample and maintains, for example, proteins of the specimen solution in their native state during subsequent image acquisition and/or data collection.

Tips of the sample manipulator are submerged in the cryogenic liquid during a vitrification process, which subjects the tips to an abrupt decrease in temperature. This change in temperature can lead to embrittlement of at least the tips of the sample manipulator and increase a likelihood of breakage. However, by adjusting the temperature of the sample manipulator using the thermoelectric system, the sample manipulator may be sufficiently warmed during vitrification to lessen adverse effects of contact with the cryogenic liquid.

For example, as the tips of the sample manipulator are submerged (or about to be submerged), Peltier devices of the sample manipulator may be activated, but in an opposite manner relative to when the tips are cooled. This can be achieved by generating a current at the Peltier devices that flows in a second direction that is opposite of a first direction of current flow, where the first direction causes heat to be drawn away from the tips, as described above. By reversing the direction of current flow, heat is instead directed to the tips, causing the temperature of the tips to increase. Warming of the tips may be controlled to offset the sudden and large decrease in temperature imposed on the tips when the tips are plunged into the cryogenic liquid. As an example, a temperature sensor coupled to the sample manipulator may be used to monitor the temperature of the tips and adjust warming of the tips based on the signal received from the temperature sensor at a controller (e.g., the controller 124 of FIG. 1). The temperature of the tips may thereby be maintained above, for example, a threshold temperature below which the tips may be subjected to failure-inducing stress resulting from differences in thermal expansion coefficients among the tips, ceramic Peltier elements coupled thereto, and/or any adhesive arranged therebetween.

In yet another embodiment, the Peltier devices and temperature sensors may be positioned at additional or alternative locations along the sample manipulator. For example, the Peltier devices may be coupled to the tips and to a body of the sample manipulator. Signals from the temperature sensors may be used in a feedback loop to adjust operation of the Peltier devices to minimize a temperature differential between the tips and the body of the sample manipulator. This may assist in prolonging a useful lifetime of the sample manipulator by reducing a likelihood of detachment between the tips and the body of the sample manipulator. For example, differences in physical properties of materials from which the tips and the body are formed of (e.g., material-based differences with respect to thermal contraction and expansion) as well as physical properties of an interface between the tips and the body (e.g., an adhesive or fastening device coupling the tips to the body). As such, specific portions of the sample manipulator may be selectively warmed or cooled to attain, as an example, a consistent temperature or target temperature differentials across the sample manipulator. The Peltier devices may also be used to heat or cool one portion of the sample manipulator to conductively heat or cool another portion of the sample manipulator.

In yet another embodiment, a cooled sample manipulator may be used to slowly evaporate the sample in a controlled manner, up to the desired liquid film thickness. The thickness of the liquid film is determined by monitoring the grid with a camera. Evaporation of the film is achieved by a combination of temperature control (offset with respect to dewpoint) and time. Once the desired thickness is reached, the sample manipulator is rapidly plunged into liquid ethane to vitrify the sample.

In yet another embodiment, a cooled sample manipulator may be used to facilitate deposition of multiple specimens onto a single grid. For example, a first specimen of a first type is deposited onto the grid to provide a sample, and a liquid layer formed of the first specimen is made thin. The sample is to be rapidly vitrified to prevent evaporation of the thin layer. By using the cooled sample manipulator, the evaporation is sufficiently suppressed to allow time to perform additional depositions of a second specimen of a second type, a third specimen of a third type, etc., at different regions of the grid before vitrification is performed.

As described herein, by implementing a sample manipulator with a thermoelectric system into a sample preparation apparatus to secure, handle, and manipulate a sample, a temperature of the sample may be readily controlled and adjusted. In least one example, this, in combination with moderation of humidity, allows evaporation of a liquid sample film of the sample to be suppressed during preparation of the sample for subsequent analysis. The thermoelectric system of the sample manipulator may be further used to selectively moderate a temperature of one or more portions of the sample manipulator to provided targeted temperature control across the sample manipulator.

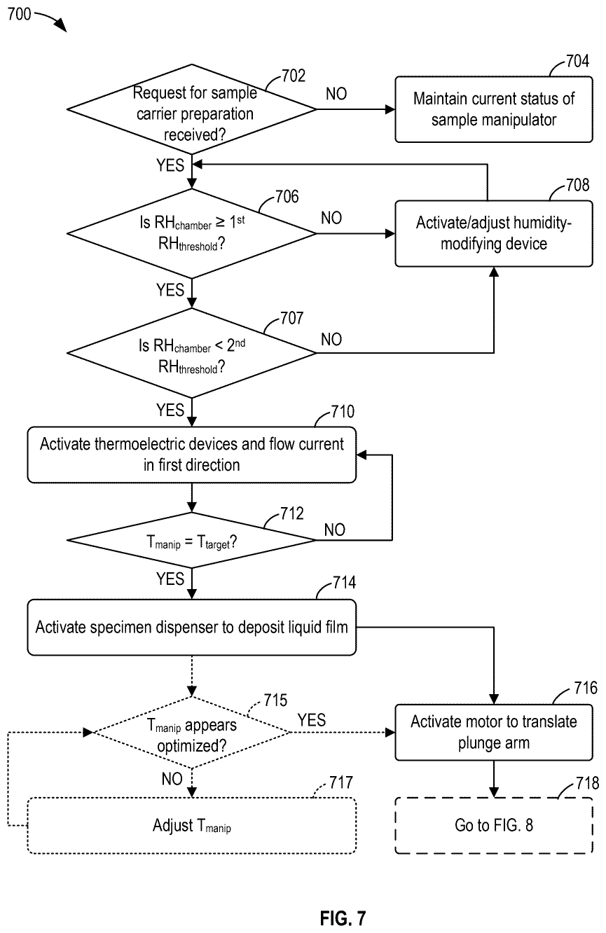

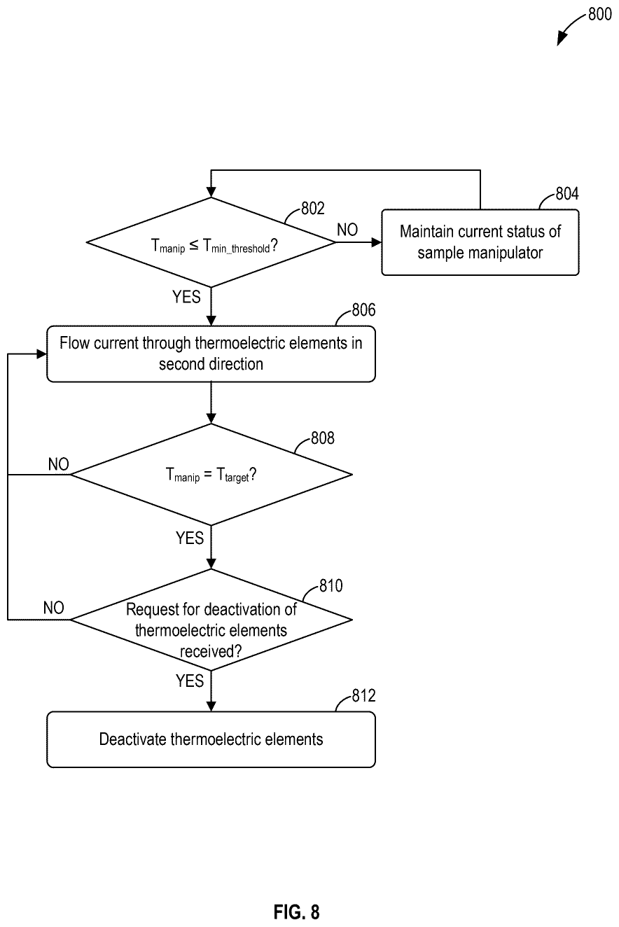

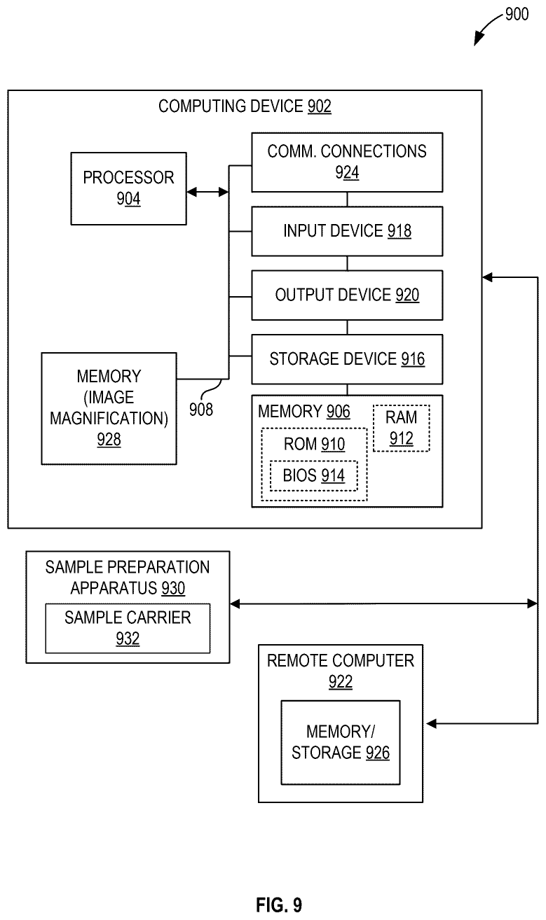

An example of a method 700 for operating a sample preparation apparatus is shown in FIG. 7 and an example of a method 800 for adjusting a temperature of a sample manipulator is shown in FIG. 8. In at least one embodiment, the sample preparation apparatus is the sample preparation apparatus 100 of FIG. 1, and includes the sample manipulator, which is configured with a thermoelectric system, and a humidity-modifying device, similar to the sample manipulator 102 and 200 of FIGS. 1 and 2 and the humidity-modifying device 138 of FIG. 1. At least a portion of the methods 700 and 800 may be performed by a controller, such as the controller 124 of FIG. 1 or a controller 900 of FIG. 9 described further below. The controller may include memory with executable instructions to cause one or more processors of the control system to control actuatable components of the sample preparation apparatus, such as a motor that causes a plunge arm to be translated along an axis of the sample preparation apparatus, and thermoelectric elements, or Peltier devices, of the sample manipulator's thermoelectric system. The executable instructions further cause the one or more processors to receive signals from components that are electronically coupled to the control system, such as one or more temperature sensors, humidity sensors, position sensors, etc. The controller may receive the signals and command operation of the actuators based on information from the signals.

Turning to FIG. 7, at 702, the method 700 includes determining if a request for preparation of a sample carrier is received. In at least one embodiment, the sample carrier is a TEM grid that is to receive a liquid specimen solution. The request may be input by, for example, a user at an input device of the controller, such as an input device 911 shown in FIG. 9. The request may include an indication that the sample carrier is engaged by the sample manipulator (e.g., tips of the sample manipulator are gripping an edge of the sample carrier) and preparation for deposition of a droplet of a sample solution is desired.

If the request is not received, the method 700 includes proceeding to 704 maintain a current status of the sample manipulator, as well as of a sample preparation chamber of the sample preparation apparatus. If the request is received, the method 700 includes continuing to 706 to determine if a relative humidity of an environment or atmosphere within the sample preparation chamber is greater than or equal to a first threshold relative humidity, which may be determined based on feedback from at least one humidity sensor positioned in the sample preparation chamber. The first threshold relative humidity may be, for example, a minimum relative humidity that allows the environment of the sample preparation chamber to be within a threshold margin (e.g., 10%) of a target dewpoint that may be dependent upon an ambient temperature in the sample preparation chamber. In other examples, the threshold margin may be within 5%, 15%, or a percentage less than 15% of the target dewpoint. For example, the environment in the sample preparation chamber may be at an ambient temperature of 23 °C (e.g., as determined based on at least one temperature sensor positioned in the sample preparation chamber) and 30% relative humidity, which corresponds to a dewpoint of 9 °C. As such, cooling of the specimen to 9 °C or below is demanded to suppress evaporation of a liquid film of, for example, 50 nm thickness. In order to decrease an amount of cooling required (and thereby an amount of time for sample preparation), the relative humidity may be increased to elevate the dewpoint. As one example, the relative humidity may be increased to 90%, which corresponds to a dewpoint of 21 °C. This maintains the dewpoint at below the ambient temperature of the sample preparation chamber but only requires a small amount of cooling (e.g., to effect a decrease of 2 °C) to cause a rate of evaporation of a liquid within the sample preparation chamber to be equal to a rate of condensation of the liquid.

If, at 706, the relative humidity in the sample preparation chamber is confirmed to be lower than the first threshold relative humidity, the method 700 includes proceeding to 708 to cause the humidity-modifying device to be activated or adjusted to increase a humidity in the sample preparation chamber. As an example, by increasing the humidity (e.g., such that the dewpoint is below the ambient temperature in the sample preparation chamber by a threshold margin), the dewpoint of the environment in the sample preparation chamber also increases. As described above, as the dewpoint increases, an amount of cooling of the sample manipulator to cause a temperature of the sample to be at or below the dewpoint decreases, thereby reducing an amount of power demanded to cool the sample manipulator. The method 700 then includes returning to 706 to confirm whether the relative humidity in the sample preparation chamber is greater than or equal to the first threshold relative humidity. The relative humidity may be adjusted until a target level of relative humidity is achieved in the sample preparation chamber, after which operation of the humidity-modifying device may be moderated to maintain the relative humidity at the target level.

If, at 706, the relative humidity in the sample preparation chamber is equal to or greater than the first threshold relative humidity, the method 700 includes continuing to 707 to determine if the relative humidity in the sample preparation chamber is less than a second threshold relative humidity. The second threshold relative humidity may a relative humidity corresponding to a dewpoint that is equal to the ambient temperature in the sample preparation chamber. For example, if the relative humidity is increased such that the dewpoint in the sample preparation chamber is equal to or greater than the dewpoint, moisture may condense out of the air in the sample preparation chamber and collect on the specimen, sample manipulator, and other surfaces within the sample preparation chamber.

If the relative humidity in the sample preparation chamber is not less than the second threshold relative humidity, the method 700 includes proceeding to 708 to adjust the humidity-modifying device to decrease the relative humidity. For example, a setting of the humidity-modifying device may be altered to cause less water vapor to be injected into the sample preparation chamber. Alternatively or additionally, moisture in the sample preparation chamber may be purged, e.g., by a vent, and air with a lower vapor content may be injected into the sample preparation chamber.

If the relative humidity in the sample preparation chamber is less than the second threshold relative humidity, the method 700 includes continuing to 710 to cause the thermoelectric elements of the sample manipulator to be activated and to flow a current across the thermoelectric elements along a first direction. When the current flows along the first direction, heat is drawn away from the tips of the sample manipulator and directed to, for example, the plunge arm coupled to the sample manipulator. An amount of power supplied to the thermoelectric elements depends on the dewpoint corresponding to the environment of the sample preparation chamber (e.g., as determined based on ambient temperature and relative humidity).

At 712, the method 700 includes determining whether the temperature of the sample manipulator (e.g., at the tips) is equal to a target temperature, where the temperature of the sample manipulator is determined based on at least one temperature sensor coupled to the sample manipulator. The target temperature, for example, may be the dewpoint. For instance, in the example described above with reference to 706 of the method 700, the target temperature may be 21 °C. When the sample manipulator is at the target temperature, the sample is also adjusted to the target temperature based on conduction. By adjusting the temperature of the sample to the target temperature (e.g., the dewpoint), evaporation of a specimen solution applied to the sample carrier can be suppressed.

If the temperature of the sample manipulator is not at the target temperature, the method 700 includes returning to 710 to continue activating the thermoelectric elements. In at least one example, power supplied to the thermoelectric elements may be increased to cause the temperature of the sample manipulator to be further reduced.

If the temperature of the sample manipulator is at the target temperature, the method 700 includes proceeding to 714 to cause a sample dispenser or applicator (e.g., the applicator 120 of FIG. 1) to be activated. In at least one embodiment, when the temperature of the specimen is confirmed to be at the target temperature, activation of the thermoelectric elements may be adjusted to maintain the sample manipulator at the target temperature. For example, the amount of power supplied to the thermoelectric elements may be increased or decreased based on feedback from the temperature sensor coupled to the sample manipulator. When activated, the sample dispenser may dispense a droplet (e.g., 230 pL) of a specimen solution onto the sample carrier of the sample. The droplet may form a liquid film on the sample carrier of, for example, 50 nm in thickness.

At 716, the method 700 includes activating the motor. By activating the motor, the plunge arm is translated along the axis (e.g., moved downwards) and the sample is submerged in a cryogenic liquid stored in a vessel arranged below the plunge arm. A position of the plunge arm may be monitored (e.g., based on feedback from a position sensor) and activation of the motor may be terminated when the plunge arm is detected to be in a position where the specimen is fully submerged in the cryogenic liquid to a depth where only the tips of the sample manipulator, and the sample, are in contact with the cryogenic liquid, or a position where only the sample is in contact with the cryogenic liquid. The sample is thereby vitrified. Optionally, the method 700 may proceed to the method 800 of FIG. 8.

In at least one embodiment, the method 700 may include optional steps subsequent to activation of the specimen dispenser at 714. For instance, after depositing the liquid film, the method 700 may optionally include continuing to 715 to confirm if the temperature of the sample manipulator appears to be optimized. Confirmation that the sample manipulator temperature is optimized may be determined based on visual monitoring of the sample provided by a camera (e.g., the camera 122 of FIG. 1). Visual monitoring of the sample may be desirable when temperature control alone is not sufficient to ensure that the sample chamber environment is adhering to a target dewpoint or may be used to efficiently and accurately inspect the sample to supplement temperature control.

For example, an image of the sample acquired by the camera may be observed to determine whether the sample manipulator is cooled beyond a desirable extent (e.g., condensation is visible on the sample carrier or sample manipulator tips) or the sample manipulator is not sufficiently cooled (e.g., liquid film is shrinking and/or disappearing). If, at 715, visual monitoring of the sample indicates that the temperature of the sample manipulator is not optimized (e.g., condensation or evaporation at the sample is visually observed), the method 700 includes proceeding to 717 to adjust the temperature of the sample manipulator. For example, if condensation is observed at the sample and/or sample manipulator, the amount of power provided to the thermoelectric elements may be decreased. Conversely, if evaporation is observed at the sample, the amount of power provided to the thermoelectric elements may be increased. The method 700 then includes returning to 715 to obtain confirmation that the sample manipulator temperature appears to be optimized.

If, at 715, the temperature of the sample manipulator appears to be optimized (e.g., no condensation or evaporation observed), the method 700 includes continuing to 716 to activate the motor to translate the plunge arm.

The method 800 illustrates moderation of the temperature of the sample manipulator when the thermoelectric elements are activated. While the method 800 is described in the context of submergence of at least a portion of the sample manipulator in the cryogenic liquid, the method 800 may be performed in a variety of other scenarios where control of the temperature of the sample manipulator is desirable.

At 802, the method 800 includes determining if the temperature of the sample manipulator, e.g., at a portion that is monitored by a temperature sensor, is less than or equal to a minimum threshold temperature. In at least one embodiment, the minimum threshold temperature is a predetermined temperature that is dependent on properties of the sample manipulator components and corresponds to a temperature at or below which a likelihood of degradation of the sample manipulator is increased. As one example, when the sample manipulator temperature decreases to or below the minimum threshold temperature, a likelihood of embrittlement and breakage of a corresponding portion of the sample manipulator (e.g., the portion that is being monitored by the temperature sensor) is increased. In another example, the minimum threshold temperature is a predetermined temperature below which a temperature differential between the corresponding portion of the sample manipulator and an adjacent portion of the sample manipulator is sufficiently large to increase a likelihood of detachment between the portions.

If the sample manipulator temperature is not at or below the minimum threshold temperature, the method 800 includes proceeding to 804 to maintain a current status of the sample manipulator. The method 800 includes returning to 802 to compare the temperature of the sample manipulator to the minimum threshold temperature.

If the sample manipulator temperature is at or below the minimum threshold temperature, the method 800 includes continuing to 806 to selectively flow a current across the thermoelectric elements of the sample manipulator in a second direction, opposite of the first direction that causes cooling of the sample manipulator tips. In at least one embodiment, changing the flow of current from the first direction to the second direction (e.g., if the current is currently or was previously flowing along the first direction) includes activating a switch or relay circuit to automatically reverse connections connecting the thermoelectric elements to a power supply (e.g., reversing a polarity of an applied voltage). Alternatively, a notification may be displayed or indicated to a user that the current is to be reversed to prompt the user to manually reverse the connections.

By selectively reversing the direction of the current in response to the sample manipulator temperature decreasing to or below the minimum threshold temperature, heat is drawn from, for example, the plunge arm to the tips of the sample manipulator (or some other portion of the sample manipulator that the thermoelectric elements are coupled to). A selected portion of the sample manipulator is thereby warmed.

At 808, the method 800 includes determining if the temperature of the sample manipulator is equal to a target temperature. In at least one embodiment, the target temperature may be a temperature above which warming of the sample manipulator may cause undesirable warming of the specimen. For example, when the specimen and the sample manipulator tips are submerged in the cryogenic liquid, the target temperature may be a temperature above which a temperature differential between the sample manipulator tips and the specimen may cause the specimen to increase in temperature. In one example, the target temperature is higher than the minimum threshold temperature of 802.

If the sample carrier temperature is not equal to the target temperature, the method 800 includes returning to 806 to continuing flowing the current through the thermoelectric elements along the second direction. The amount of power supplied to the thermoelectric elements may be varied according to a difference between the sample manipulator temperature and the target temperature. For example, the amount of power delivered to the thermoelectric elements may be decreased by a determined amount to cause the temperature of the sample manipulator to decrease to the target temperature.

If the sample manipulator temperature is equal to the target temperature, the method 800 continues to 810 to determine if a request for deactivation of the thermoelectric elements is received. For example, the request may be input by a user at the user input device of the controller. As another example, the request may be generated automatically in response to an indication that the plunge arm is to be translated (e.g., upwards).

If the request is not received the method 800 includes returning to 806 to continue flowing the current through the thermoelectric currents in the second direction. If the request is received, the method 800 includes proceeding to 812 to deactivate the thermoelectric elements. For example, the power supply may be disconnected from the thermoelectric elements.

FIG. 9 and the following discussion are intended to provide a brief, general description of an exemplary computing environment in which the disclosed technology may be implemented. In particular, some or all portions of this computing environment can be used with the above methods and apparatus to, for example, adjust a temperature of a sample manipulator 932 which may be similar to the sample manipulator 102 of FIG. 1 or 200 of FIG. 2) in combination with providing dewpoint control of a sample preparation chamber 930 (which may be similar to the sample preparation chamber 130 of FIG. 1). For example, the exemplary controller 900 illustrated in FIG. 9 may be an embodiment of the controller 124 of FIG. 1 and used as described above with reference to FIGS. 7 and 8, as well as elsewhere herein. Although not required, the disclosed technology is described in the general context of computer executable instructions, such as program modules, being executed by a computer. Generally, program modules include routines, programs, objects, components, data structures, etc., that perform particular tasks or implement particular abstract data types. Moreover, the disclosed technology may be implemented with other computer system configurations, including handheld devices, tablets, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices. As used herein, the term “processor” refers to CPUs and other logical processing devices such as FPGAs, ASICs, and CPLDs. A control system or other controller generally includes at least one processor as well as additional components such as memory, communication buses, and others as discussed below.

With reference to FIG. 9, an exemplary system for implementing the disclosed technology includes a general-purpose computing device 902 of the controller 900 that includes one or more processors, or processing units, 904, a system memory 906, and a system bus 908 that couples various system components including the system memory 906 to the one or more processors 904. The system bus 908 may be any of several types of bus structures including a memory bus or memory controller, a peripheral bus, and a local bus using any of a variety of bus architectures. The exemplary system memory 906 includes read only memory (ROM) 910 and random-access memory (RAM) 912. A basic input/output system (BIOS) 914, containing the basic routines that help with the transfer of information between elements within the computing device 902, is stored in ROM 910.

The computing device 902 further includes one or more storage devices 916 such as a hard disk drive for reading from and writing to a hard disk, a magnetic disk drive for reading from or writing to a removable magnetic disk, a memory device such as a thumb drive, and an optical disk drive for reading from or writing to a removable optical disk (such as a CD-ROM or other optical media). Such storage devices can be connected to the system bus 908 by a hard disk drive interface, a magnetic disk drive interface, and an optical drive interface, respectively. The drives and their associated computer readable media provide nonvolatile storage of computer-readable instructions, data structures, program modules, and other data for the computing device 902. Other types of computer-readable media which can store data that is accessible by a computing device, such as magnetic cassettes, flash memory cards, digital video disks, CDs, DVDs, RAMs, ROMs, and the like, may also be used in the exemplary operating environment. As used herein, memory, storage devices and the like refer to non-transitory storage, i.e., not propagating signals.

A number of program modules may be stored in the storage devices 916 including an operating system, one or more application programs, other program modules, and program data. A user may enter commands and information into the computing device 902 through one or more input devices 918 such as a keyboard and a pointing device such as a mouse. For example, the user may enter commands at a user interface of the computing device 902 to cause thermoelectric elements of a sample manipulator 932 to be activated. Other input devices may include a digital camera, microphone, joystick, game pad, satellite dish, scanner, or the like. These and other input devices are often connected to the one or more processing units 904 through a serial port interface that is coupled to the system bus 908 but may be connected by other interfaces such as a parallel port, game port, universal serial bus (USB), or wired or wireless network connection. One or more output devices 920, such as a monitor or other type of display device, is also connected to the system bus 908 via an interface, such as a video adapter, and can display, for example, information regarding a current status of the sample preparation chamber and/or menus or lists of instructions that can be selected by the user. Other peripheral devices, such as speakers and printers (not shown), may be included in the output device 920. The computing device 902 may operate in a networked environment using logical connections to one or more remote computers, such as a remote computer 922. In some examples, one or more network or communication connections 924 are included. The remote computer 922 may be another computing device, a server, a router, a network PC, or a peer device or other common network node, and typically includes many or all of the elements described above relative to the computing device 902, although only a memory storage device 926 has been illustrated in FIG. 9. The computing device 902 and/or the remote computer 922 can be connected to a local area network (LAN) and a wide area network (WAN). Some or all functions provided by the computing device 902 can be provided by the remote computer 922.

As shown in FIG. 9, a memory 928 of the computing device 902 (or portions of this or other memory) stores processor executable instructions for moderation of a temperature of the sample manipulator 932 and humidity control of the sample preparation chamber 930. The memory 928 further stores processor executable instructions for operating components of the sample preparation chamber 930 and adjusting the sample carrier temperature. In addition, the memory 928 can store look-up tables providing relationships between ambient temperature, relative humidity, and dewpoint, as well as threshold and target temperatures, as described above with reference to FIGS. 7 and 8.

Further details of the present disclosure are provided in the following paragraphs:

In one embodiment, a sample preparation apparatus comprises a sample preparation chamber, a humidity-modifying device in fluid communication with an inner volume of the sample preparation chamber, and a sample manipulator comprising one or more thermoelectric elements in contact with at least one or more tips of the sample manipulator. The sample manipulator grips a sample carrier within the sample preparation chamber. Additionally, the apparatus includes a controller with memory and executable instructions that, when executed, cause the controller to activate the humidity-modifying device to adjust the relative humidity within the sample preparation chamber, connect the thermoelectric elements to a power supply, and adjust the power provided to the thermoelectric elements based on the adjusted relative humidity. In another embodiment that the preceding embodiment, heat is drawn away from the tips of the sample manipulator when the thermoelectric elements are connected to the power supply. In another embodiment that includes any of the preceding embodiments, the adjusted relative humidity corresponds to a dewpoint within the sample preparation chamber that is below the ambient temperature by a threshold margin. In another embodiment that includes any of the preceding embodiments, the power provided to the thermoelectric elements is adjusted to cause the temperature of the tips to correspond to the dewpoint within the chamber environment. In another embodiment that includes any of the preceding embodiments, when the sample carrier is a transmission electron microscope (TEM) grid, the power adjustment reduces the carrier's temperature to the dewpoint within the sample preparation chamber. In another embodiment that includes any of the preceding embodiments, if a droplet of solution is deposited onto the sample carrier, the power adjustment causes the evaporation rate of the droplet to equal the condensation rate of vapor in the chamber. In another embodiment that includes any of the preceding embodiments, the sample manipulator also comprises heat pipes coupled to the thermoelectric elements, transferring heat to a portion of the apparatus away from the manipulator.

In one embodiment, a method comprises activating a humidity-modifying device to adjust the relative humidity within a sample preparation chamber, providing power to thermoelectric elements coupled to a sample manipulator positioned within the chamber, and depositing a solution onto a sample carrier to form a liquid film. The power provided is based on the adjusted relative humidity and the temperature of the chamber. In another embodiment that includes the preceding embodiment, the relative humidity is adjusted to cause the dewpoint within the chamber to be below the chamber's temperature by a threshold margin. In another embodiment that includes any of the preceding embodiments, providing power to the thermoelectric elements involves selecting an amount of power based on the dewpoint within the chamber. In another embodiment that includes any of the preceding embodiments, a camera is used to visually monitor the liquid film's status, and the power provided to the thermoelectric elements is adjusted based on this status. In another embodiment that includes any of the preceding embodiments, depositing the solution involves applying a sub-nanoliter volume to the sample carrier, forming a liquid film with a thickness of 60 nanometers or less. In another embodiment that includes any of the preceding embodiments, the thermoelectric elements are coupled to the tips of the sample manipulator, which are made of a heat-conductive material. In another embodiment that includes any of the preceding embodiments, after the solution is deposited, the sample carrier and manipulator tips are submerged in a cryogenic liquid, and the temperature of the tips is increased using the thermoelectric elements. In another embodiment that includes any of the preceding embodiments, increasing the temperature involves adjusting the direction of current flow across the thermoelectric elements.

In one embodiment, a sample manipulator comprises a body, tips formed of a heat-conductive material coupled to the body, and thermoelectric elements coupled to the tips. These elements adjust the tips' temperature to a target temperature based on the relative humidity of the surrounding environment. In another embodiment that includes the preceding embodiment, the target temperature is the dewpoint of the environment, and a current flows in a first direction across the thermoelectric elements to cool the tips to the dewpoint. In another embodiment that includes any of the preceding embodiments, if the tips cool below a predetermined threshold temperature, the current selectively flows in the opposite direction to warm the tips, preventing degradation. In another embodiment that includes any of the preceding embodiments, the manipulator also includes temperature sensors coupled to the tips, adjusting the power to the thermoelectric elements based on signals from these sensors. In another embodiment that includes any of the preceding embodiments, the tips are configured to contact a transmission electron microscope specimen.

While the present disclosure has been described in detail with reference to specific embodiments, it will be apparent to those skilled in the art that various modifications and changes can be made without departing from the spirit and scope of the disclosure. Accordingly, the specification and drawings are to be regarded in an illustrative rather than a restrictive sense.

What is claimed is:

1. A sample preparation apparatus, comprising:
a sample preparation chamber;
a humidity-modifying device in fluid communication with an inner volume of the sample preparation chamber;
a sample manipulator comprising one or more thermoelectric elements in contact with at least one or more tips of the sample manipulator, the sample manipulator gripping a sample carrier within the sample preparation chamber; and
a controller comprising memory with executable instructions stored thereon that, when executed, cause the controller to:
activate the humidity-modifying device to cause a relative humidity within the sample preparation chamber to be adjusted;
connect the one or more thermoelectric elements to a power supply; and
adjust an amount of power provided to the thermoelectric elements from the power supply based, at least in part, on the adjusted relative humidity.

2. The sample preparation apparatus of claim 1, wherein heat is drawn away from the one or more tips of the sample manipulator when the one or more thermoelectric elements are connected to the power supply.

3. The sample preparation apparatus of claim 1, wherein the adjusted relative humidity corresponds to a dewpoint within the sample preparation chamber that is below an ambient temperature of the sample preparation chamber by a threshold margin.

4. The sample preparation apparatus of claim 1, wherein the amount of power provided to the thermoelectric elements is adjusted to cause a temperature of the one or more tips of the sample manipulator to correspond to a dewpoint of an environment within the sample preparation chamber.

5. The sample preparation apparatus of claim 1, wherein the sample carrier is a transmission electron microscope (TEM) grid, and wherein the amount of power provided to the thermoelectric elements is adjusted to cause a temperature of the sample carrier to be reduced to a dewpoint of an environment within the sample preparation chamber.

6. The sample preparation apparatus of claim 1, wherein a droplet of a solution is to be deposited onto the sample carrier, and wherein adjustment of the amount of power supplied to the thermoelectric elements causes a rate of evaporation of the droplet to equal a rate of condensation of vapor in the inner volume of the sample preparation chamber.

7. The sample preparation apparatus of claim 1, wherein the sample manipulator comprises one or more heat pipes coupled to the thermoelectric elements, and wherein the one or more heat pipes transfer heat from the thermoelectric elements to a portion of the sample preparation apparatus away from the sample manipulator.

8. A method, comprising:
activating a humidity-modifying device to cause a relative humidity within a sample preparation chamber to be adjusted;
providing power to one or more thermoelectric elements coupled to a sample manipulator positioned within the sample preparation chamber, wherein the power is provided based on the adjusted relative humidity and a temperature of the sample preparation chamber; and
depositing a solution onto a sample carrier in contact with the sample manipulator to form a liquid film across the sample carrier.

9. The method of claim 8, wherein the relative humidity is adjusted to cause a dewpoint of an environment within the sample preparation chamber to be below the temperature of the sample preparation chamber by a threshold margin.

10. The method of claim 8, wherein providing the power to the one or more thermoelectric elements comprises selecting an amount of power that is delivered to the one or more thermoelectric elements based, at least in part, on a dewpoint of an environment within the sample preparation chamber, and wherein the dewpoint corresponds to the adjusted relative humidity and the temperature of the sample preparation chamber.

11. The method of claim 8, further comprising using a camera to visually monitor a status of the liquid film, and adjusting the power provided to the one or more thermoelectric elements based on the visually monitored status of the liquid film.

12. The method of claim 8, wherein depositing the solution onto the sample carrier comprises applying a sub-nanoliter volume of the solution to the sample carrier, and wherein the sub-nanoliter volume of the solution forms a liquid film with a thickness of 60 nanometers or less.

13. The method of claim 8, wherein the one or more thermoelectric elements are coupled at least to one or more tips of the sample manipulator, and wherein the one or more tips are formed of a heat-conductive material.

14. The method of claim 8, further comprising, after the solution is deposited onto the sample carrier:
submerging the sample carrier and one or more tips of the sample manipulator in a cryogenic liquid; and
increasing a temperature of the one or more tips of the sample manipulator using the one or more thermoelectric elements.

15. The method of claim 14, wherein increasing the temperature of the one or more tips of the sample manipulator comprises adjusting a direction of current flow across the one or more thermoelectric elements.

16. A sample manipulator, comprising:
a body;
tips coupled to the body, the tips formed of a heat-conductive material; and
one or more thermoelectric elements coupled to at least the tips, wherein the one or more thermoelectric elements are operable to adjust a temperature of the tips to a target temperature based on a relative humidity of an environment surrounding the sample manipulator.

17. The sample manipulator of claim 16, wherein the target temperature is a dewpoint of an environment surrounding the sample manipulator, and wherein a current is flowed in a first direction across the one or more thermoelectric elements to cool the tips to the dewpoint.

18. The sample manipulator of claim 17, wherein, in response to a detected cooling of the tips below a predetermined threshold temperature, the current is selectively flowed in a second direction, opposite of the first direction, to cause warming of the tips, and wherein the predetermined threshold temperature corresponds to a temperature at or below which a likelihood of degradation of the sample manipulator is increased.

19. The sample manipulator of claim 16, further comprising one or more temperature sensors coupled at least to the tips, and wherein an amount of power provided to the one or more thermoelectric elements is adjusted based on a signal transmitted from the one or more temperature sensors to a controller communicatively coupled to the one or more temperature sensors.

20. The sample manipulator of claim 16, wherein the target temperature is a dewpoint of an environment surrounding the sample manipulator, and wherein the tips are configured to contact a transmission electron microscope specimen.
